(19) United States
(12) Patent Application Publication
(10) Pub. No.: US 2007/0091629 A1
(43) Pub. Date: Apr. 26, 2007

(54) Vehicle Lighting Device

(76) Inventor: Kiyotaka Fukawa, Shizuoka (JP)

Correspondence Address: FISH & RICHARDSON P.C., P.O. BOX 1022, MINNEAPOLIS, MN, 55440-1022, US

(21) Appl. No.: 11/538,699

(22) Filed: Oct. 4, 2006

(30) Foreign Application Priority Data
Oct. 7, 2005 (JP) 2005-295224

(51) Int. Cl. F21V 1/00

(52) U.S. Cl. 362/509

(57) ABSTRACT

A vehicle lighting device is provided with a pair of lamps arranged on right and left sides of a front part of a vehicle. Illumination light beams emitted from the pair of lamps are overlapped with each other to illuminate a front area of the vehicle. A light distribution characteristic of only one of the lamps is independently changed and controlled. For example, a light distribution characteristic where the luminosity of a direct front area of an own vehicle is somewhat reduced may be obtained by changing the light distribution pattern of one lamp from that of the other lamp. This prevents the driver of an oncoming vehicle from being dazzled by the light reflected on a road surface in the direct front area. At the same time, this avoids the direct front area being in a substantially entirely dark state and improves the visibility of the direct front area.

This application claims foreign priority from Japanese Patent Application No. 2005-295224, filed on Oct. 7, 2005, the entire contents of which are hereby incorporated by reference.

### BACKGROUND OF THE INVENTION

1. Field of the Invention

The present invention relates to a vehicle lighting device of a vehicle such as an automobile, and in particular to a vehicle lighting device capable of appropriately controlling a light distribution characteristic of a headlamp.

2. Related Art

In order to secure the safe traveling of an automobile, it is a common practice to appropriately change and control a light distribution characteristic of a headlamp depending on a traveling situation of an automobile. The term “light distribution characteristic” refers to a pattern shape of a light intensity distribution of an area illuminated by the headlamp. Thus, the same light intensity distribution pattern shape having a different illumination direction has the same light distribution characteristic. For example, techniques described in JP-A-2004-327187 and JP-A-2005-011608 are used for controlling the light distribution characteristic of each projector-type lamp constituting the right and left headlamps of the automobile. According to the disclosed techniques, a shade mounted inside each lamp is shifted to change and control the light distribution characteristic of each lamp so as to appropriately control the light distribution characteristic ahead of the automobile where the illumination light beams emitted from both lamps overlap each other. According to JP-A-2004-327187 and JP-A-2005-011608, part of shades mounted on the right and left lamps are simultaneously moved to extinguish or dim an illumination light in a direct front area of the own vehicle thus preventing a driver of another vehicle from being dazzled by illuminating light reflected on a road surface in a rainy weather. JP-A-2003-200779 proposes a technique whereby an illuminating directions of the lamps having inherent light distribution characteristics are individually or simultaneously controlled to change the overlapping form of the illumination light from the lamps, thereby changing and controlling the light distribution characteristic.

In the techniques disclosed in JP-A-2004-327187 and JP-A-2005-011608, the right and left lamps have the same light distribution characteristic and the illumination light beams of the same light distribution characteristic overlap each other to illuminate the front area of the vehicle, so that the difference in luminosity between an area where the illumination light beams overlap each other and an area where the beams do not overlap each other is extremely eminent, which brings discomfort for a driver and degrades visibility. For example, FIG. 11 shows a light distribution characteristic assumed in case the front area of the own vehicle is illuminated by the lamp according to JP-A-2005-011608 so as not to dazzle anther vehicle with reflected light on the road surface in the direct front area of the own vehicle in the rainy weather. The area B0 where illumination light beams by the light distribution patterns LL0, RL0 of the left and right headlamps overlap each other is light, while the area B2 where only the illumination light from one of the lamps is irradiated is a little darker. The area B1 where no illumination light is irradiated from the lamps is in substantially an entirely dark state. In this light distribution characteristic, the driver cannot check the direct front area of the own vehicle because the direct front area B1 of the own vehicle is in the dark state thus degrading the visibility. The light area B0, the little darker area B2 and the substantially entirely dark area B1 are arranged side by side in the front area of the own vehicle. This results in linear-stripe-shaped light and dark across the illuminated area, which brings discomfort for the driver as well as an obstacle in terms of safety traveling.

According to the technique disclosed in JP-A-2003-200779, the light distribution characteristic of each of the lamps is fixed. It is thus possible to change the light distribution characteristic in an illuminated area where the illumination light beams overlap each other by changing the illumination direction of each lamp. However, this approach is limited to a combination of fixed light distribution characteristics thus narrowing the freedom of controllable light distribution characteristic. Thus, it is difficult to obtain a light distribution characteristic that decreases the luminosity just in front of the own vehicle in a rainy weather like in JP-A-2004-327187 and JP-A-2005-011608 prevent the driver of another vehicle from being dazzled by the reflection on the road surface. This narrows the freedom of controllable light distribution characteristic and presents an obstacle of safe traveling.

### SUMMARY OF THE INVENTION

One or more embodiments of the present invention provide a vehicle lighting device capable of preventing the driver of another vehicle from being dazzled and enhancing the driver's visibility thus obtaining a light distribution characteristic effective for safe traveling.

In accordance with one or more embodiments of the invention, a vehicle lighting device is provided with at least a pair of lamps arranged on right and left sides of the front part of a vehicle, illumination light beams emitted from the pair of lamps are overlapped each other so as to illuminate a front area of the vehicle, and a light distribution characteristic of only one of the lamps is independently changed and controlled from the other of the lamps. For example, as control of light distribution characteristic, a luminosity of a partial area out of an area illuminated by the one lamp is changed and controlled. In this case, it is preferable to dim or extinguish an illuminated area just in front of the vehicle.

In accordance with one or more embodiments of the invention, by independently changing and controlling the light distribution characteristic of only one of the lamps, it is possible to arbitrarily change the overlapping form of the illumination light of the one lamp and that of the other lamp thereby providing a vehicle lighting device having a variety of light distribution characteristics. This obtains, for example, a light distribution characteristic where the luminosity of the direct front area of the own vehicle in a rainy weather is somewhat reduced, thereby preventing the driver of an oncoming vehicle from being dazzled by the light reflected on the road surface in the direct front area. At the same time, this avoids the direct front area being in a substantially entirely dark state and improves the visibility of the direct front area of the own vehicle and prevents a linear-stripe-shaped dark and light caused by the possible substantially entirely dark state, thus relieving the driver from discomfort. It is also possible to obtain a light distribution characteristic that illuminates the areas ahead of the own vehicle with high luminosity without dazzling the driver of the oncoming vehicle in high-speed traveling.

Other aspects and advantages of the invention will be apparent from the following description and the appended claims.

### BRIEF DESCRIPTION OF THE DRAWINGS

FIG. 1 is a conceptual drawing of a lighting device.

FIG. 2 is a general perspective view of a right headlamp of a first exemplary embodiment.

FIG. 3 is a cross-sectional view of a low beam projector-type lamp.

FIG. 4 shows a cross section taken along the line A-A in FIG. 3.

FIG. 5A shows a light distribution pattern of left/right low beam projector-type lamp, where a movable shade is moved vertically upward.

FIG. 5B shows a light distribution pattern of left/right low beam projector-type lamp, where a movable shade is moved downward.

FIG. 6A shows a light distribution pattern of a traveling mode.

FIG. 6B shows a light distribution pattern of a passing mode.

FIG. 6C shows a light distribution pattern of a rainy weather mode.

FIG. 7 is a general perspective view of a right headlamp of a second exemplary embodiment.

FIG. 8A is a cross-sectional view of a high-beam source unit.

FIG. 8B is a cross-sectional view of a low-beam source unit.

FIG. 9A shows a light distribution pattern of the high-beam light source unit.

FIG. 9B shows a light distribution pattern of the low-beam light source unit.

FIG. 10A shows a light distribution pattern of a traveling mode.

FIG. 10B shows a light distribution pattern of a passing mode.

FIG. 10C shows a light distribution pattern of a rainy weather mode.

FIG. 11 shows a light distribution pattern to explain the problem of the related art light distribution characteristic.

### DETAILED DESCRIPTION OF THE EXEMPLARY EMBODIMENTS

Exemplary embodiments of the invention will be described with reference to the accompanying drawings.

### First Exemplary Embodiment

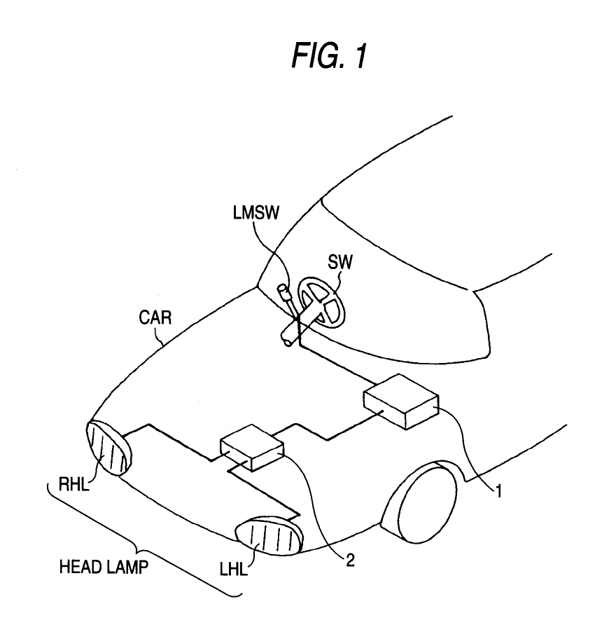

FIG. 1 is a schematic view of a first exemplary embodiment where a lighting device according to a first exemplary embodiment composed of a pair of headlamps arranged on the right and left sides of a front part of an automobile. When a driver in a driver's seat of the automobile CAR operates a lamp mode selector switch LMSW provided in close proximity to a steering wheel SW to switch between modes as described later, a central processing unit (hereinafter referred to as the CPU) 1 receives a mode signal from the lamp mode selector switch LMSW to control a lamp controller 2 to cause it to independently control the light distribution characteristic, that is, the light distribution pattern shape of each of the left headlamp LHL and the right headlamp RHL. In the first exemplary embodiment, the following lamp modes are available: “traveling mode (high beam mode)”, “passing mode (low beam mode)”, and “rainy weather traveling mode (wet road mode)”.

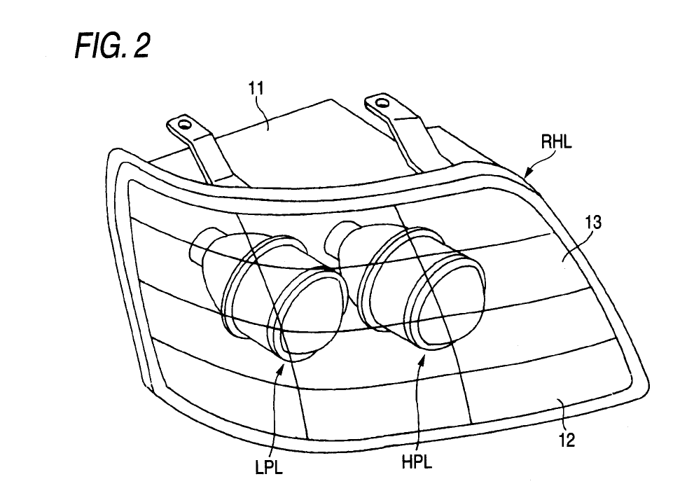

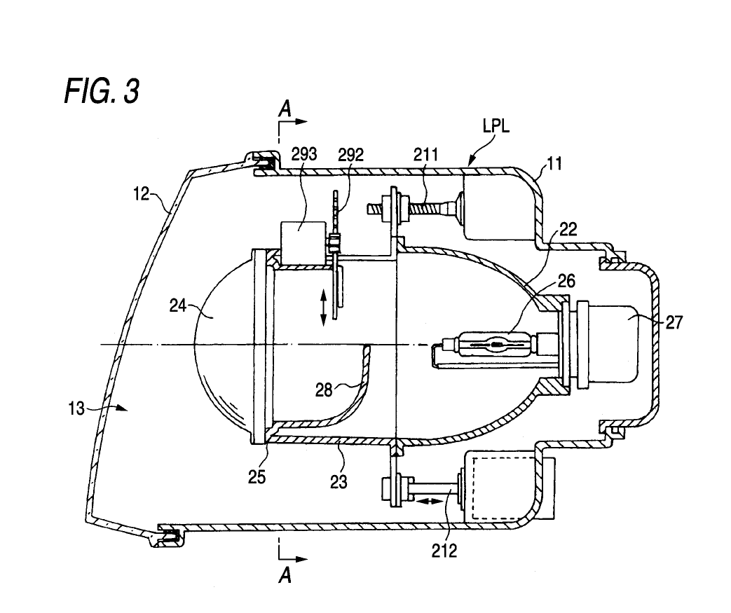

FIG. 2 is a schematic view of a right headlamp RHL as an example of the left and right headlamps LHL, RLH. The right headlamp RHL includes a lamp chamber 13 composed of a lamp body 11 and a transparent cover 12 mounted at the front opening of the lamp body 11. Inside the lamp chamber 13 are mounted a high beam projector-type lamp HPL and a low beam projector-type lamp LPL. The high beam and low beam projector-type lamps HPL, LPL basically has the same configuration although they are partially different. FIG. 3 is a sectional view of the low beam projector-type lamp LPL. The projector-type lamp LPL is supported inside the lamp body 11 via an aiming mechanism 21. The aiming mechanism 21, roughly speaking, includes aiming screws 211 arranged in the upper left and right positions and an aiming motor mechanism arranged on a lower part. By adjusting the aiming screws 211, the optical axis of the projector-type lamp LPL can be adjusted horizontally. By driving the aiming motor mechanism 212, the optical axis can be vertically adjusted.

The low beam projector-type lamp LPL has a lamp housing composed of a spheroidal reflector 22, an annular holder 23 mounted on the front edge of the reflector 22, and a lens 24 supported by a fixed ring 25 at the front edge of the holder 23. At the first focal position provided by the reflector 22 is internally mounted a discharge bulb 26 as a light source by a bulb socket 27. The lens 24 is a convex lens whose focal point is the second focal point of the reflector 22. Inside the holder 23 are arranged a first shade 28 and a second shade 29 for partially shielding the light emitted from the discharge bulb. The first shade 28 has a fixed shade structure of a required shape designed to shield the light of an area under the optical axis in the holder 23. The second shade 29 has a movable shade structure of a required shape designed to partially shield the light of an area on the optical axis in the holder 23.

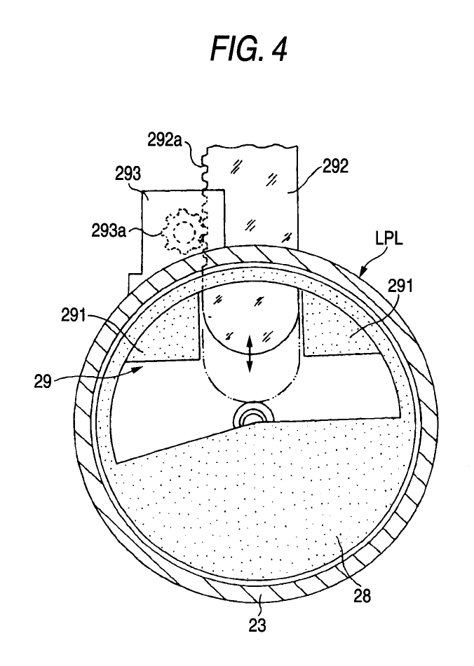

As shown by the cross-section taken along the line A-A of FIG. 3 in FIG. 4, the first shade 28 is a fixed light-shielding wall to shield the light of the area nearly under the optical axis in the holder 23. The first shade 28 has one of the right and left areas arranged horizontally and the other somewhat slanted downward. The second shade 29 includes fixed-structure auxiliary shades 291 for shielding the light of the left and right areas along the upper side the holder 23 and a movable shade 292 that can be moved vertically in a cavity of a required width dimension arranged vertically between the auxiliary shades 291. On the outside of the upper part of the holder 23 is arranged with a shade motor 293. The movable shade 292 can be moved vertically by the shade motor 293. The movable shade 292 has an arc-shaped bottom edge. On one side of the movable shade 29 are formed rack teeth 292a. The rack teeth 292a are engaged with the pinion 293a of the shade motor 293 to form a rack-and-pinion mechanism. In this configuration, driving the shade motor 293 causes the rack-and-pinion mechanism to move the movable shade in vertical direction. Typically, the bottom edge of the movable shade 292 is in nearly the same vertical position as the bottom edge of the auxiliary shade 291. In the rainy weather traveling mode or the like, the bottom edge of the movable shade 292 is lowered by the shade motor 293 and the bottom edge of the movable shade 292 protrudes downward toward the optical axis from the bottom edge of the auxiliary shade 291.

The high beam projector-type lamp HPL is basically the same as the low beam projector-type lamp LPL explained referring to FIGS. 3 and 4, except that shades corresponding to the first shade 28 and the second shade 29 are not provided inside the holder 23 of the lamp housing. Similarly, the left headlamp LHL includes a high beam and low beam projector-type lamps although horizontal arrangement of the projector-type lamps is opposite to that of the right headlamp RHL.

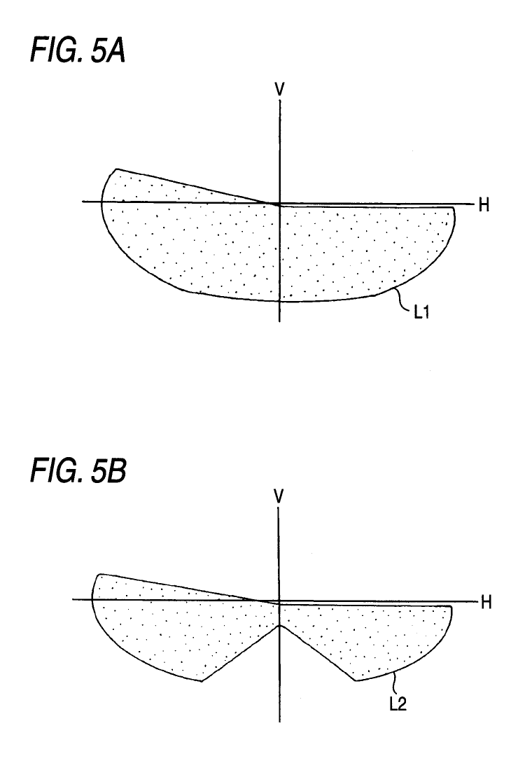

For the low beam projector-type lamp LPL of the left/right headlamp LHL, RHL, when the discharge bulb 26 is turned on the light emitted from the discharge bulb 26 is reflected on the inner surface of the spheroidal reflector 22, condensed at the second focal point, passes through the lens 24, and is emitted as a nearly parallel luminous flux. The first shade 28 is arranged at the second focal point. The light is emitted in a radiation pattern of a required cut line by way of the first shade 28. In a state where the movable shade 292 of the second shade 29 is moved vertically upward to a withdrawal position, that is, the bottom edge of the movable shade 292 is aligned with the bottom edge of the auxiliary shade 291, the light distribution characteristic provided by the first shade 28 and the second shade 29 has a light distribution pattern L1 where a horizontal cut line is formed below a horizon H in the right-side area of the optical axis and a cut line slanted upward from the right-side area is formed in the left-side area of the optical axis, as shown in FIG. 5A. When the movable shade 292 is moved downward and its bottom edge is protruded vertically downward from the bottom edge of the auxiliary shade 291, the portion along the optical axis of the illumination light that is reflected on the reflector 22 and passes above the optical axis in the holder 23 is shielded. The light distribution characteristic of the illumination light has a light distribution pattern L2 where the light of a part along the vertical line V of the optical axis of the area immediately under the horizon H, that is, the light of the direct front area of a own vehicle is shielded or dimmed by the movable shade 292, as shown in FIG. 5B.

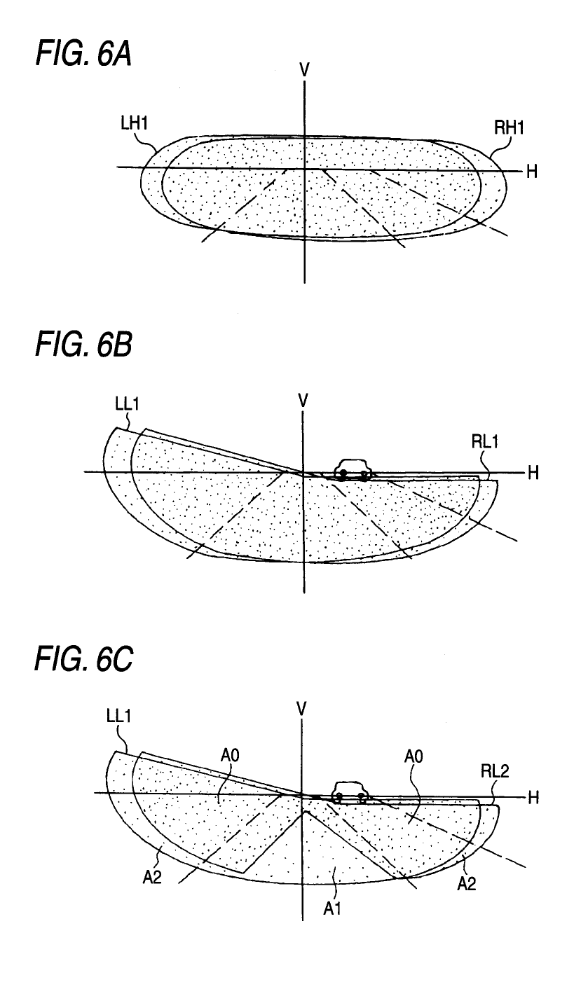

The light distribution characteristic in each mode according to the first exemplary embodiment will be described. In the arrangement of the first exemplary embodiment, when the driver operates the lamp mode selector switch LMSW to the “traveling mode”, the high beam projector-type lamp HPL of each of the left and right headlamps LHL, RHL is turned on. In the high beam projector-type lamp HPL, the light from the discharge bulb 26 is reflected on the reflector 22, passes through the lens 24, and is emitted toward all forward areas which the illumination light beams from the high beam projector-type lamp HPLs of the headlamps LHL, RHL overlap each other thus providing the light distribution characteristic shown in FIG. 6A. In FIG. 6A, LH1 is the light distribution pattern of the high beam projector-type lamp HPL of the left headlamp LHL, and RH1 is the light distribution pattern of the high beam projector-type lamp HPL of the right headlamp RHL. Light distribution of the left/right high beam projector-type lamp HPL is slightly dislocated in horizontal direction.

When the lamp mode selector switch is operated to the “passing mode”, the low beam projector-type lamp LPL of each of the left and right headlamps LHL, RHL is turned on. The low beam projector-type lamps LPL of the left and right headlamps have a light distribution characteristic including the same cut lines as shown in FIG. 5A. As shown in FIG. 6B, the light distribution pattern LL1 of the low beam projector-type lamp of left headlamps LHL overlaps with the light distribution pattern RL1 of the low beam projector-type lamp LPL of right headlamps RHL slightly in horizontal direction. This provides illumination having a passing light distribution characteristic with enhanced light intensity.

When the lamp mode selector switch LMSW is operated to the “rainy weather traveling mode”, the light distribution characteristic of only one of the low beam projector-type lamps LPLs of the left and right headlamps LHL, RHL is changed. In this example, the light distribution characteristic of only the low beam projector-type lamp LPL of the headlamp corresponding to the opposite side lane in consideration of dazzling of the driver of an oncoming vehicle, that is, of the right headlamp RL is changed. In other words, the shade motor 293 of the low beam projector-type lamp LPL of the right headlamp RL is driven to cause the bottom edge of the movable shade 292 to protrude toward the optical axis positioned vertically below from the auxiliary shade 291. The protruding movable shade 292 results in the light distribution characteristic of the low beam projector-lamp LPL being a light distribution characteristic where light distribution to the direct front area of the own vehicle is extinguished or dimmed as shown in FIG. 5B. When the illumination light beams of the low beam projector-type lamps LPLs of the left and right headlamps LHL, RHL overlap each other as shown in FIG. 6C, the light distribution characteristic of the low beam projector-type lamp LPL of the left headlamps LHL has the same light distribution pattern LL1 as that shown in FIG. 5A while the low beam projector-type lamp LPL of the right headlamp RHL has the same light distribution pattern RL2 as that shown in FIG. 5B.

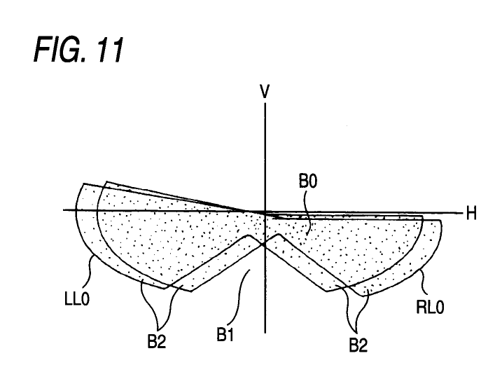

To be more precise, the areas A0, A2 that occupy most of the direct front area of the own vehicle where the illumination light beams of the low beam projector-type lamps LPLs of the left and right headlamps LHL, RHL overlap each other has the same light distribution characteristic as that in the passing mode. In the direct front area of the own vehicle A1 in FIG. 6C, the illumination light from the low beam projector-type lamps LPL of the right headlamp RHL is extinguished or dimmed so that what is obtained is the illumination light from the low beam projector-type lamp LPL of the left headlamp LHL alone that provides a light distribution characteristic with a less reduced luminosity. This prevents the light reflected on the road surface in the direct front area A1 of the own vehicle in a rainy weather from dazzling the driver of an oncoming vehicle. In this light distribution characteristic, even in case illumination light beams from both the left and right low beam projector-type lamps LLPL, RLPL overlap each other, the direct front area A1 of the own vehicle is not in the substantially entirely dark state so that the visibility of the direct front area A1 is improved. The light distribution characteristic obtained has a bright area A0 where the illumination light beams from the left and right low beam projector-type lamps LPLs overlap each other and the areas A1, A2 where the brightness is slightly reduced because the illumination light from only one of the low beam projector-type lamps LPLs is obtained. There remains no substantially entirely dark area such as in the related art light distribution characteristic shown in FIG. 11. The result is that the light distribution area has no conspicuous stripe-shaped light and dark without bringing the discomfort for the driver and corresponding improvement in visibility.

### Second Exemplary Embodiment

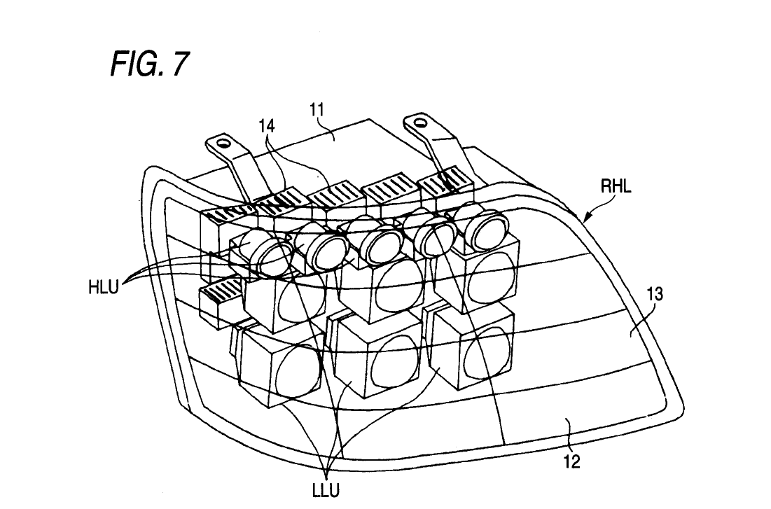

In a lighting device of a second exemplary embodiment, the driver can switch between the “traveling mode”, the “passing mode” and a “middle beam mode”. The “middle beam mode” is a mode callable of illuminating far front area of the own vehicle traveling at a high speed while preventing dazzling of the driver of an oncoming vehicle. FIG. 7 is a schematic view of a right headlamp RHL according to the second exemplary embodiment as an example of the left and right headlamps LHL, RHL of an automobile configured similarly to FIG. 1. A plurality of high beam light source units HLUs and low beam light source units LLUs are arranged in a lamp chamber 13 composed of a lamp body 11 and a transparent cover 12 mounted at the front opening of the lamp body 11. Each light source unit HLU, LLU includes an optical semiconductor device, an LED (light-emitting diode) in this example, as a light source. Each light source unit illuminates light in a predetermined light distribution characteristic. Inside the lamp chamber 13 is arranged a heat sink 14 for dissipating heat from the light source units HLU, LLU. Inside the lamp chamber 13 is also arranged a circuit unit (not shown) for causing each light source unit to illuminate and an extension (not shown) for concealing the areas except the light source units in the lamp chamber 13 and the circuit unit.

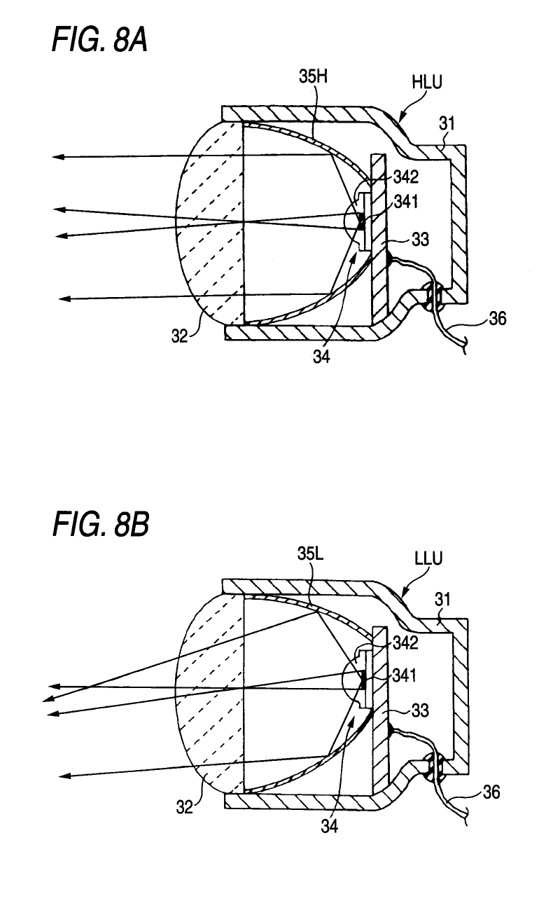

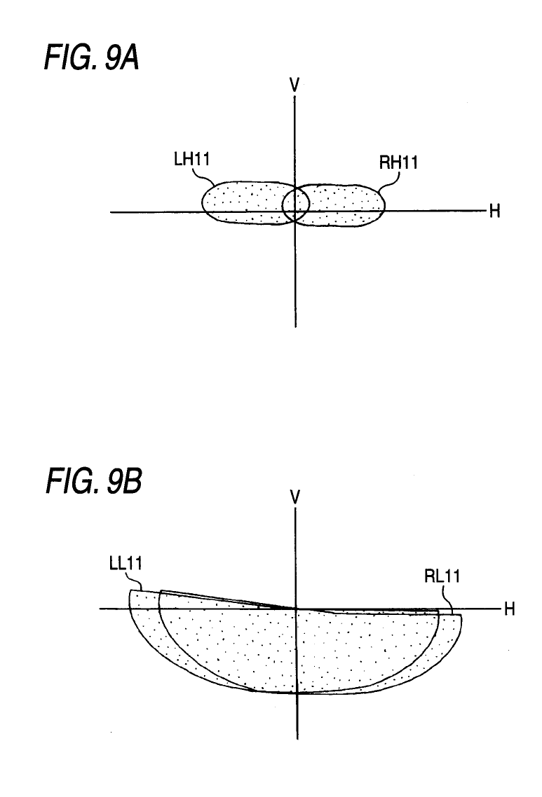

FIG. 8A is a cross sectional view of the high beam light source unit HLU. At the front opening of the unit housing 31 is mounted a lens 32. Inside the unit housing 31 are arranged an LED module 34 as a light source and a reflector 35H. The LED module 34 is composed of an LED 341 and a transparent resin 342 sealing the LED 341 and is mounted on a support board 33 fixed inside the unit housing 31. The LED module 34 is electrically connected to a circuit unit (not shown) via an electrical cord 36 connected to the support board 31 and illuminate by way of a car-mounted power source. The transparent resin 342 is formed into a required curved plane and emits the light from the LED 341 in a required direction. The reflector 35H reflects the light emitted from the LED module 34 and causes the reflected light to outgo via the lens 32 to obtain a required light distribution characteristic. In the high beam light source unit HLU, the LED module 34 is arranged on the optical axis of the lens 32. The direct light from the LED module 34 and the light reflected on the reflector 35H are condensed by the lens 32 and the outgoing illumination light as a nearly parallel luminous flux is directed in horizontal direction along the optical axis of the headlamp to show a light distribution characteristic to illuminate the close proximity to the optical axis. In the second exemplary embodiment, as shown in FIG. 9A, the illumination light from the high beam light source unit HLU of the left headlamp LHL has a light distribution characteristic to illuminate the area LH11 along the horizon in the area on the left side of the optical axis. The illumination light from the high beam light source unit HLU of the right headlamp RHL has a light distribution characteristic to illuminate the area RH11 along the horizon in the area on the right side of the optical axis.

As shown in the sectional view of FIG. 8B, while the low beam light source unit LLU basically has almost the same configuration as the high beam light source unit HLU, the LED module 34 is supported in a position on the support board 33 deflected vertically upward with respect to the optical axis of the lens 32. The reflector 35L partially includes a plurality of reflective surfaces of different inclinations. Thus, the low beam light source unit LLU of each of the left and right headlamps LHL, RHL provides a light distribution characteristic LL11, RL11 where the light emitted from the LED module 34 directly passes through the lens 32 or is reflected on the reflector 35L and passes through the lens 32 thus illuminating the area having a cut line slightly below the horizon in the area on the right side of the optical axis and illuminating the area having a cut line along the horizon in the area on the left side of the optical axis as shown in FIG. 9B.

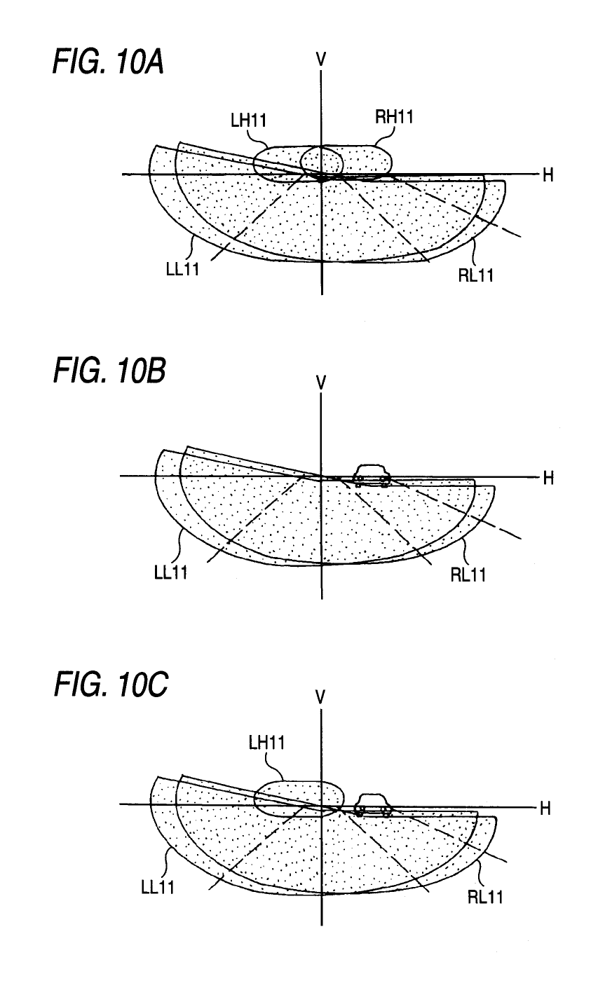

The light distribution characteristic in each mode according to the second exemplary embodiment will be described. When the lamp mode selector switch LMSW is operated to the “traveling mode”, the high beam light source unit HLU and the low beam light source unit LLU of the left and right headlamps LHL, RHL are turned on. The illumination light beams from the high beam and low beam light source units HLU, LLU of the left and right headlamps LHL, RHL overlap each other in the front area of an automobile. The resulting light distribution characteristic has light distribution patterns LL11, RL11 where the left and right areas under the horizon are illuminated by the low beam light source units LLUs of the left and right headlamps and the left and right areas along the horizon are illuminated by the high beam light source units ELUs of the left and right headlamps, with LH11 and RL11 overlapping each other as shown in FIG. 10A.

When the lamp mode selector switch LMSW is operated to the “passing mode”, only the low beam light source unit LLU of each of the left and right headlamps LHL, RLH is turned on. Overlapping the illumination light beams from the low beam light source units LLUs of the left and right headlamps provides a light distribution characteristic where the distribution patterns LL11, RL11 illuminating only the left and right areas under the horizon overlap each other as shown in FIG. 10B. This no longer dazzles the driver of another vv such as an oncoming vehicle.

When the lamp mode selector switch LMSW is operated to the “middle beam mode”, the low beam light source unit LLU of each of the right and left headlamps LHL, RHL is turned on. At the same time, the high beam light source unit HLU of the headlamp on the side that has no possibility of dazzling the driver of an oncoming vehicle, in this example the left headlamp LL, is turned on. In other words, the high beam light source unit HLU of the headlamp on the side that could dazzle the driver of an oncoming vehicle, in this example the right headlamp RL, is not turned on. Overlapping the illumination light beams from the left and right headlamps LHL, RHL each other provides light distribution patterns LL11, RL11 where the left and right areas under the horizon are illuminated by the low beam light source units LLUs of the left and right headlamps and a light distribution pattern LH11 where the left area along the horizon is illuminated by the high beam light source unit HLU of the left headlamp LL, with LL11, RL11 and LH11 overlapping one on the other as shown in FIG. 10C. As a result, the right area along the horizon is not illuminated by the high beam light source unit of the right headlamp. In the right area facing an oncoming vehicle, only the area under the horizon is illuminated thus obtaining a light distribution characteristic to prevent the driver of the oncoming vehicle from being dazzled.

Thus, according to a second exemplary embodiment, in the “passing mode” and “middle beam mode”, it is possible to secure proper illumination corresponding to the traveling state of the own vehicle without dazzling the driver of the oncoming vehicle thereby improving the visibility. By overlapping each other the illumination light beams of different light distribution characteristics from left and right headlamps, an area with high luminosity and an area with low luminosity are unlikely to appear and stripe-shaped light and dark are unlikely to occur across the illuminated area, thereby relieving the driver from discomfort.

The first and second exemplary embodiments assume a left-side driving, that is, a driving mode where an oncoming vehicle travels on the right side of an own vehicle. In the case of a right-side driving, the direct front area of the own vehicle is dimmed or extinguished with the left headlamp facing the oncoming-vehicle side in the rainy weather traveling mode in the first exemplary embodiment. In the second exemplary embodiment, the high beam light source unit of the left headlamp is not turned on in the middle beam mode.

The invention is implemented by independently change and control the light distribution characteristic of one of the left and right headlamps as long as the illumination light beams from the headlamps overlap each other to obtain a predetermined light distribution characteristic. Thus, a specific configuration of the headlamps is not limited to the first and second exemplary embodiments. For example, it is possible to perform light distribution in the middle beam mode of the second exemplary embodiment by using the projector-type lamp of the first exemplary embodiment. In addition, it is possible to perform light distribution in the rainy weather traveling mode of the first exemplary embodiment by using light source module lamp of the second exemplary embodiment. While the lamp mode selector switch LMSW is manually operated in the foregoing exemplary embodiments, the light distribution characteristic of the headlamp may be automatically switched based on the velocity of the automobile, a wiper operation signal, the surrounding of the own vehicle photographed with a car-mounted camera, and information obtained from communications involving the own vehicle.

It will be apparent to those skilled in the art that various modifications and variations can be made to the described exemplary embodiments of the present invention without departing from the spirit or scope of the invention. Thus, it is intended that the present invention cover all modifications and variations of this invention consistent with the scope of the appended claims and their equivalents.

What is claimed is:

1. A vehicle lighting device comprising:
at least a pair of lamps arranged on right and left sides of a front part of a vehicle, illumination light beams emitted from the pair of lamps being overlapped so as to illuminate a front area of the vehicle,
wherein a light distribution characteristic of only one of the lamps is changed and controlled independently from the other of the lamps.

2. The vehicle lighting device according to claim 1, wherein the light distribution characteristic is changed and controlled by changing and controlling a luminosity of a partial area of an illuminated area of the one of the lamps.

3. The vehicle lighting device according to claim 2, wherein an illuminated area directly in front of the vehicle is dimmed or extinguished.

4. The vehicle lighting device according to claim 1, wherein an illumination light beam emitted from the one of the lamps is dimmed or extinguished in an illuminated area directly in front of the vehicle, and an illumination light beam from the other of the lamps is emitted to the illuminated area directly in front of the vehicle so as to reduce the luminosity in the illuminated area directly in front of the vehicle.

5. The vehicle lighting device according to claim 1, wherein the illumination light beam from a left lamp has a light distribution characteristic to illuminate an area on the left side of an optical axis, and
the illumination light beam from a right lamp has a light distribution characteristic to illuminate an area on the right side of an optical axis.
